(19) United States
(12) Patent Application Publication
(10) Pub. No.: US 2024/0157648 A1
(43) Pub. Date: May 16, 2024

(54) PROCESS CHAMBER FOR AN ADDITIVE MANUFACTURING APPARATUS AND METHOD FOR OPERATING THE PROCESS CHAMBER

(71) Applicant: Nikon SLM Solutions AG, Lübeck (DE)

(72) Inventors: Birk Hoppe, Lübeck (DE); Karsten Neumann, Lübeck (DE); Tobias Schmithüsen, Lübeck (DE)

(21) Appl. No.: 18/502,639

(22) Filed: Nov. 6, 2023

Related U.S. Application Data
(63) Continuation of application No. PCT/EP2022/061835, filed on May 3, 2022.

(30) Foreign Application Priority Data
May 7, 2021 (DE) 10 2021 111 964.2

(51) Int. Cl. B29C 64/371; B29C 64/153; B29C 64/25; B33Y 10/00; B33Y 30/00

(52) U.S. Cl. CPC B29C 64/371; B29C 64/153; B29C 64/25; B33Y 10/00; B33Y 30/00

(57) ABSTRACT

A process chamber housing for an additive manufacturing apparatus with a process chamber (having a bottom, a ceiling, and side walls that jointly enclose a volume of the process chamber), an inert gas inlet in a front wall of the side walls (to provide an inert gas into the process chamber) and an inert gas outlet in a rear wall of the side walls (to release the inert gas out of the process chamber). When the inert gas inlet and the inert gas outlet are positioned at opposite sides of the opening of the housing and face towards each other to establish an inert gas flow in a main flow direction from the inert gas inlet over the opening to the inert gas outlet, the quality of laser beam(s) employed in the additive manufacturing process is improved.

### CROSS-REFERENCE TO RELATED APPLICATIONS

This US Patent Application is a continuation of the pending International Patent Application No. PCT/EP2022/061835 filed on May 3, 2022 and now published as WO 2022/233860, which designates the United States and claims priority from the German Patent Application No. DE 10 2021 111 964.2 filed on 7 May 2021. The disclosure of each of the above-identified patent documents is incorporated herein by reference.

### RELATED ART

### 1. Field of the Invention

The invention relates to additive manufacturing by fusing a powder bed. In particular, the invention relates to a process chamber housing for an additive manufacturing apparatus. The process chamber housing comprises a process chamber with a bottom, a ceiling and side walls, jointly enclosing a volume of the process chamber. An inert gas inlet, e.g. in a front wall of the side walls, enables to provide an inert gas into the process chamber and an inert gas outlet, e.g. in a rear wall of the side walls, is provided to release the inert gas out of the process chamber.

### 2. Description of Related Art

Additive manufacturing is a growingly important and capable method of manufacturing 3D workpieces. There are different variants of additive manufacturing, but herein we focus on methods and an apparatus for joining powder particles by selectively heating powder particles, e.g., on top of a bed of powder particles to adhere some of the particles to each other. The powder particles are adhered to each other by sintering, fusing and/or welding (hereinafter jointly “fused”). The heat for these processes is typically provided by focused radiation, for example by an electron beam or by a laser beam. These beams selectively heat portions of the top layer of the powder bed, thereby attaching particles of the top layer to particles of a preceding layer. This process is generally referred to as powder bed fusion process or simply powder-fusion process. Herein, we will not distinguish between different types of radiation and will simply refer to “beam” or “beams”.

Modern apparatuses for powder-bed fusion have a housing with a process chamber. The process chamber has a support-opening for accommodating a movable support. Initially, a thin layer of powder is applied to the support. This is mostly accomplished by a recoater (see e.g. WO 2018/156264 A1, WO 2017/143145A1, EP 1 234 625 A and DE102006056422B3, to name only a few.) Once a layer has been subjected to the beam treatment a subsequent powder layer is applied, which then again is selectively fused. This process is iterated until additive manufacturing of the workpiece has been completed. Further treatment of the workpiece such as, e.g. grinding, cutting, milling etc. may still be required.

As taught, e.g. by EP 3 321003, the process chamber is advantageously filled with an inert gas. During the additive manufacturing process, the inert gas flows from a gas inlet over the bottom and thus over the top layer of powder on the support to a gas outlet. EP 3 321 003 aims for an essentially laminar flow of inert gas to thereby remove fumes, smoke or other side products of the fusing process (hereinafter jointly “smoke”). To this end, the inlet opening is made of a porous material to thereby release an essentially homogenous flow of the inert gas through the process chamber. The choice of the inert gas has been discussed in WO 2012/3828 A1, WO2020/064147A1, WO2020/064148A1 or WO 2020/126086 A1 and specifically an Argon (Ar) or Nitrogen (N₂) atmosphere with an oxygen concentration below 1000 ppm (parts per million) have been suggested. The addition of Helium (He) to the inert gas atmosphere has been suggested as well to allow for higher laser scanning speeds.

The initial powder bed fusion process suffered from being slow and there have been many attempts to decrease the manufacturing time, e.g. by using multiple beam sources simultaneously to thereby decrease the costs associated to a given additively manufactured workpiece. The difficulty of this approach is that a second beam may not fuse any portion of the powder bed while a smoke plume originating from the operation of a first beam is located in between of the second beam source and the corresponding portion of the powder bed without severely compromising the quality of the workpiece. These smoke plumes appear to distort, absorb and scatter the beams and accordingly many concepts have been developed to avoid fusing of portions of the powder bed being shadowed by smoke plumes originating from scanning the powder bed by other beams (see e.g., WO 2016/075026 A or WO 2020/178216A).

### SUMMARY

The problem to be solved by the invention is to improve the powder bed process.

The process chamber housing includes a process chamber with a bottom, a ceiling and side wall. The bottom, the ceiling and the side wall jointly enclose a volume of the process chamber. In an embodiment, at least one inert gas inlet may be in a front wall of the side walls and configured to provide an inert gas into the volume of the process chamber. At least a portion of the inert gas being provided to the volume can be removed via at least one inert gas outlet in a rear wall of the side walls, hence the inert gas outlet may be configured to release the inert gas out of the process chamber. Alternatively or additionally, the gas inlet and/or the gas outlet may be provided in the ceiling, the bottom, in different or the same one of the side walls. The gas inlet and the gas outlet may be arranged preferably at opposite sides of the process chamber.

The bottom may have an opening. The opening may be delimited by opening walls. Preferably, a vertically movable support configured for supporting the powder bed and hence a three-dimensional (3D) object being manufactured by selectively fusing the powder bed may located in between of the opening walls. As already apparent, the support may preferably be movably supported in the opening. For example, the support may be retracted further into the opening (i.e. lowered assuming a horizontal support surface) prior to adding a new layer of powder to the powder bed.

The opening walls may be and/or provide linear bearings restricting the movement to a direction at least essentially perpendicular to the edge being formed by the transition between the bottom and the opening walls. At least essentially perpendicular indicates that perpendicular is preferred, but small deviations, e.g. smaller 1°, 2.5°, 5° and/or 10° can be accepted. The opening walls may enclose a space for example a box or a circular cylinder. This space may accommodate already fused portions of the powder bed. The opening walls may be configured to be removed from the process chamber housing. This enables to simply replace the opening walls after a workpiece has been manufactured by an empty set of walls.

Preferably, the inert gas inlet and the inert gas outlet are positioned at opposite sides of the opening and face towards each other. This thus enables to provide a main inert gas flow in a main flow direction by injecting an inert gas via the (first) inert gas inlet while removing inert gas from the volume via the (first) inert gas outlet, or in other words by providing a pressure gradient from the inert gas inlet to the inert gas outlet. This main inert gas flow may preferably be at least essentially parallel to an up-facing surface of the bottom and/or the optional support. The main inert gas flow may as well have an upward or downward component. In a preferred example, the direction of the main inert gas flow has a non-vanishing component being parallel to the bottom and/or the support. This non-vanishing component provides for a direction in which smoke plumes being produced when scanning the powder bed with the beam are inclined relative to the vertical.

In a preferred example, the gas inlet may be connected to an inert gas source providing a He-comprising inert gas. The inert gas source may preferably be configured to provide an inert gas including at least Helium (He) and one of another noble gas (i.e. at least one of Neon (Ne), Argon (Ar), Krypton (Kr), Xenon (Xe), Radon (Rn)) and/or Nitrogen (N2). The inert gas source may be configured to provide the He-including inert gas from the inert gas source into the volume of the process chamber. Particularly preferred, the inert gas source provides a gas comprising at least one of 20%, 30%, 40%, 50%, 60%, 70%, 80%, 90%, 95%, 98%, 99% He and/or Ne, wherein the percentage relates to the amount mol He and/or Ne, respectively, relative to the total amount of gas in mol.

Unexpectedly it turned out that replacing Ar or N₂ by He and/or Ne enables to fuse portions of the powder bed with a second beam being emitted by a second beam source while smoke being produced by a first beam being emitted by first beam source is located in between of the beam outlet of a second beam source and the portion of the powder bed to be fused. Hence, an embodiment may include the step of fusing a powder bed using at least two beams, while at least one second beam is controlled to fuse a location of the powder bed being covered by a smoke plume being generated by fusing another portion of the powder bed with another beam (the at least one first beam), wherein the smoke plumes are removed from the process chamber by a main inert gas flow, wherein the main inert gas flow is established by an inert gas comprising at least 20% of He and/or Ne, and/or having a density below at least one of 1.4 kg/m³ 1.2 kg/m³, 1 kg/m³, 0.6 kg/m³, 0.4 kg/m³ and 0.2 kg/m³. The density references preferably to normal conditions (0° C., 1013 hPa) but may as well reference to the actual conditions in the process chamber. In other words, the at least one second beam source operates downstream of the beam spot of the another beam source, wherein downstream relates to the main inert gas flow direction over the powder bed. Being covered is intended to express that the smoke plume is in the beam path of the at least one second beam. As already mentioned, the beam sources are preferably laser beam sources, but not limited to these. The usage of the term “laser beam” or “laser beam source” herein is to be understood as a preferred example of for “beam” or “beam source”. In operation the beam source may be pivoted to thereby scan locations to be fused on the powder bed. For example, a mirror being pivoted to project a laser beam onto said locations on the powder bed can be considered as a beam source, even if the beam is not generated by the mirror itself. In this application the location from which beam is emitted towards a location of the powder bed is relevant, not the type of beam or the beam generation device.

Different from all prior art teachings, operating in the smoke plume being produced by scanning a portion of the powder bed with the first beam is made possible by replacing at least a portion of the Ar and/or N₂ by He and/or Ne. Further investigations revealed that the smoke in these smoke plumes has a comparatively low impact on the quality of a fused area being fused by a penetrating a smoke plume of produced by another beam. These observations render it plausible that the heat induced density change in the smoke plumes are responsible laser beam distortions leading to a defocusing of an otherwise well focused beam and/or to a change of the beam profile and/or to change of the beam intensity distribution over the beam profile. The lower density of He and/or Ne combined with the increased heat conductivity of He and/or Ne, provides for lower density gradient between hotter and colder portions of the inert gas flow and hence to a reduced effect of defocusing. The positive effect of reducing laser beam distortion due to thermal inhomogeneities in the inert gas flow can be further enhanced by reducing the amount of gas in the volume, i.e. by operating the process chamber at pressures below ambient pressure. Lowering the pressure significantly may even allow to use Ar and/or N₂ as inert gas (, or to simply use air), i.e. to omit He and/or Ne. Another advantage of lowering the pressure (i.e. of reducing the amount of gas molecules in the volume) may be that the flow speed of the inert gas flow can be increased without shifting (blowing away) powder particles previously deposited on the powder bed by the inert gas flow.

Particularly preferred, the inert gas has a thermal conductivity at or above at least one of

$$0.15 \frac{W}{m \cdot K} , 0.1 \frac{W}{m \cdot K} , 0.05 \frac{W}{m \cdot K} , 0.025 \frac{W}{m \cdot K} and 0.02 \frac{W}{m \cdot K}$$

at normal conditions (0° C., 1013 hPa) and/or a thermal conductivity at or above at least one of

$$0.15 \frac{W}{m \cdot K} , 0.1 \frac{W}{m \cdot K} , 0.05 \frac{W}{m \cdot K} , 0.025 \frac{W}{m \cdot K} and 0.01 \frac{W}{m \cdot K}$$

at the conditions in the process chamber.

In a preferred example, the inert gas flow may have a flow speed in the main flow direction may and that the mean flow speed measured 0.5 cm over the opening may be above 0.75 m/s preferably above 1 m/s and/or below 4 m/s preferably below 3 m/s even more preferred below 2.5 m/s at 1013 hPa. These boundaries may preferably be increased if the gas pressure in the volume of the process chamber is decreased and/or if the molar mass of the gas is decreased.

In a preferred example, the process chamber includes at least one oxygen sensor and/or a gas density sensor and/or thermal conductivity sensor and/or thermal capacity sensor configured to determine a value being representative for the thermal conductivity and/or thermal capacity, respectively of the inert gas. At least one of these sensors may preferably be located in the bottom portion of the volume. For example, at least one of these sensors may be located on the bottom and/or in a recess of the bottom and/or below a distance of 5 cm above the bottom and/or on the support and/or below the support, and/or at or within at least one of 10 cm, 5 cm, 2.5 cm, 1 cm, 0.5 cm from the edge encircling the opening. In another example, at least one of these sensors may preferably be located in the (first) inert gas outlet, preferably at the bottom of the (first) inert gas outlet and/or within at least one of 10 cm, 5 cm, 2.5 cm, 1 cm, 0.5 cm from the edge encircling (first) inert gas outlet. Each of these example locations enable to measure the Oxygen concentration in the vicinity of the powder bed. Oxygen has a higher mass per molecule (16u) and will therefore accumulate in the bottom portion of the volume if He (4u) and/or Ne (10u) may be used as inert gas (as usual, u is the unified atomic mass unit). Thus, potential leaks or impurities provided by the gas source can be detected quickly. Further the measurement is as representative as possible for the oxygen level right over the powder bed. In addition or alternatively, at least one of the sensors may be located in a duct connecting at least one inert gas outlet with at least one inert gas inlet.

The at least one Oxygen sensor and/or a gas density sensor and/or thermal conductivity sensor and/or thermal capacity sensor may preferably be located in the inert-gas flow through the chamber. Particularly preferred, the respective sensor may be oriented at least essentially parallel to the inert gas flow, wherein at least essentially parallel indicates that parallel is preferred but that deviations within a few degrees (e.g., within ±30°, ±20°, 10°, ±5°, ±2.5°, ±1° or 0°) can be accepted,

The at least one Oxygen sensor and/or a gas density sensor may preferably be coupled to a process chamber controlling device, i.e. to an electronic circuitry configured for controlling operation of the process chamber and/or an entire additive manufacturing apparatus with the process chamber (hereinafter simply “controller”). In particular if, e.g. the oxygen level is above a predefined threshold, the controller may increase the flow speed of the inert gas flow over the opening, e.g. by increasing the power provided to a vacuum pump being connected to the inert gas outlet and/or by opening a throttle valve upstream of the inert gas inlet. Further, prior to fusing the powder bed, the process chamber may preferably be flooded with the inert gas. Once the oxygen level is below a predefined threshold the inert gas may be circulated from the inert gas outlet to the inert gas inlet using an inert gas pump to thereby establish the inert gas flow.

In a preferred example, the process chamber may include a gas component concentration sensor being configured to measure a value being representative for at least one of the concentrations of O₂, N₂, He, Ne, Ar, Kr, Xe, Rn and/or for a ratio of at least two of these gases in the inert gas. The gas component sensor may be located or have a gas inlet at the positions indicated above for the oxygen sensor. The above referenced sensors can be considered as examples for a gas component concentration sensor. In other words, a gas component concentration sensor may be or include at least one of an Oxygen sensor and/or a gas density sensor and/or a thermal conductivity sensor and/or thermal capacity sensor and/or a gas chromatograph and/or a spectrometer and/or gas-analyzer, in particular He-analyzer. Further, it is noted that partial pressure values of O₂, N₂, He, Ne, Ar, Kr, Xe, Rn may be considered as representative for at least one of the concentrations of these gases if the total pressure is known. A simple and yet efficient way to measure concentrations may thus be to measure the partial pressure of at least one of these gases, e.g. via the diffusion rate through a semipermeable membrane. For example, if a semipermeable membrane is permeable only for He, the diffusion rate through the membrane at a given differential pressure between the spaces being separated by the membrane can be used to determine the partial pressure of He in the inert gas.

The gas component concentration sensor may preferably be coupled to the process chamber controlling device by a data line. Hence, the values obtained by the gas component concentration sensor may be made available to the process chamber controlling device.

In any embodiment the method may include feeding at least a portion of the inert gas being removed through the inert gas outlet via the inert gas inlet to the process chamber. This is as well referred to a recycling or circling the inert gas.

A method for fusing at least a portion of the powder bed may thus include to control the composition of an inert gas flow being established above the powder bed.

The method may include determining the concentration and/or partial pressure of at least one of O₂, N₂, He, Ne, Ar, Kr and Xe in the inert gas flow established above the powder by determining the concentration and/or partial pressure of at least one of O₂, N₂, He, Ne, Ar, Kr and Xe in the inert gas in the process chamber and/or being removed from the process chamber via the at least one inert gas outlet and/or being provided via the inert gas inlet to the process chamber. The method may further include obtaining a measurement value being representative for the concentration and/or partial pressure of at least one of O₂, N₂, He, Ne, Ar, Kr and Xe in the inert gas and comparing this measurement value with a lower limit and/or with an upper limit for the concentration and/or the partial pressure of the respective at least one of O₂, N₂, He, Ne, Ar, Kr and Xe in the inert gas. It is noted that O₂ is not inert and hence should not be comprised in the inert gas. But monitoring the unintended O₂-concentration may be used to increase the concentration(s) of inert components of the inert gas to thereby reduce the partial pressure and the concentration of the O₂, what can be considered as effectively removing unintended O₂ from the process chamber and hence the fusing process.

In case said comparing provides that this measurement value is below a lower limit, the method may include adding the corresponding depleted component to the inert gas stream in the process chamber, e.g., by adding it to an inert gas stream circling from the inert gas outlet to the inert gas inlet and through the process chamber, while adding no or less of at least one other component of the inert gas mixture to the inert gas mixture. “less” in this context references to the amount of the depleted component, i.e. the amount added of the at least other component being added is less than the amount added of the depleted component.

Similarly, in case said comparing provides that this measurement value is above an upper limit, the method may include adding the at least one other component to the inert gas in the process chamber, e.g. by adding it to an inert gas stream fed from the inert gas outlet via duct to the inert gas inlet (thereby into the process chamber) than said component having a measurement value above the upper limit, while adding no or less of said component having a measurement value above the upper limit. Similarly to the above “less” references to the amount the at least one other component is added. In other words, more of the at least one other component is added than of the component having a measurement value above the upper limit.

This method allows to partially and selectively replenish only those components of the inert gas that are underrepresented in a given composition as defined by the upper and lower boundaries for the respective components. This helps to keep operating costs low, while maintaining high workpiece quality. These method steps are based on the observation that for practical purposes the inert gas may often be a mixture of essentially He and/or Ne with Ar and/or with N₂ wherein the concentrations of He, Ne, Ar, and N₂ in the mixture are well defined. However, He and Ne diffuse at a significantly higher rate through the duct wall and the other confining structures of the process chamber housing. The method thus allows to maintain the partial He and/or Ne-pressure and/or the He and/or Ne-concentration in the inert gas within given limits, while not replacing He and/or Ne-depleted inert gas from the process chamber by (costly) “fresh” inert gas. By measuring a value being representative for the, e.g., He and/or Ne-concentration (and/or partial pressure) and adding only He and/or Ne to the inert gas circling through the process chamber housing, if a He and/or Ne-depletion below the lower limit for He and/or Ne, respectively, has been observed. This approach can be used for any other of the inert gases mentioned above, i.e. curing a He and/or Ne-depletion is only a preferred example. Any other depletion can be resolved by adding the depleted component(s), preferably only.

These steps of controlling the composition of an inert gas flow being established above the powder bed may be executed by the process chamber controlling device, as well referred to as “controller”. In other words, the process chamber controlling device may be configured to execute the any of the above method steps, be it directly or by controlling and or communicating with corresponding components, such as, e.g., a gas component concentration sensor.

The corresponding process chamber housing may thus include the process chamber controlling device. The process chamber controlling device may be connected to at least one gas component concentration sensor, e.g., via a data line and/or any other data transmission means. This gas component concentration sensor may be located in the process chamber. Alternatively or in addition, the (or another) gas component concentration sensor may be located at, attached to and/or integrated in a duct connecting the inert gas outlet with the inert gas inlet.

The process chamber may further include an inert gas component source including only a component or a limited number of components of the inert gas in the process chamber. For example, the inert gas component source may comprise only He and/or Ne but no Ar or N₂ if the inert gas is a mixture of all three gases. In practice it is sufficient if the concentration of the depleted inert gas component in the gas provided by the inert gas component source is greater than the preset or intended concentration of the depleted component in the inert gas, as in this case adding the gas mixture from the inert gas component source increases the concentration of component being depleted in the inert gas circling through the process chamber and the duct connecting the inert-gas outlet with the inert-gas inlet.

The process chamber may also include more than one inert gas component sources, including respectively one different inert gas component and/or including different inert gas mixtures.

As usual “limited number of components” means that at least one component of the (intended) inert gas mixture may not be included or underrepresented in the inert gas component source. The inert gas component source may be fluidly connected via at least one inert gas component valve with the inert gas-inlet or with a separate gas inlet, e.g. via a branch of the duct. A fluid connection via the duct may be preferred, as the concentrations of the components of the inert gas being provided to the process chamber homogenize. In other words, the inert gas in the process chamber has a more homogenous composition.

The process chamber controlling device may be connected via e.g. at least one control line and/or a contactless data connection to the inert gas component valve, thereby being enabled to open and close the inert gas component valve.

In another preferred example, the process chamber includes a heater configured to heat the temperature of at least a portion of the inert gas flow through the process chamber to or above at least one of 25° C., 40° C., 60° C., 80° C., 100° C., 150° C., 250° C., 300° C., 350° C., 400° C., 450° C., 500° C., 600° C., 700° C., 800° C., 900° C., 1000° C. When using higher temperatures, the process chamber housing may preferably be thermally isolated. By this increase of the gas temperature, the temperature gradient in a smoke plume is decreased and thus beam distortion of the smoke plume is reduced if not neglectable small.

As already explained above, the process chamber preferably includes a pressure controller, configured to maintain the pressure inside the process chamber below ambient pressure outside the process chamber and/or at or below at least one of 1000 hPa, 900 hPa, 800 hPa, 700 hPa, 600 hPa, 500 ha, 400 hPa, 300 hPa, 200 hPa, 100 hPa. The pressure controller may be integrated or form a part of a process chamber controller. In another preferred example, the pressure in the process chamber may be above ambient pressure, thereby ensuring that no oxygen may be sucked accidentally into the process chamber. In another example, the process chamber may be enclosed in another housing, and the pressure in the process chamber may be below ambient pressure, while the pressure in the volume being defined by the boundary of the process chamber and the another housing may be above ambient pressure and in that the gas said volume may as well be an inert gas, preferably the same as in the process chamber. This enables to ensure a lower pressure in the process chamber while at the same time reducing the risk that oxygen is accidentally sucked into the process chamber, because the volume between the boundary of the process chamber and the another housing may be filled with an inert gas and may have a pressure above ambient pressure.

For example, the inert gas outlet may be in fluid communication with a low pressure inlet of a gas pump (e.g. a vacuum pump inlet) e.g. via the above mentioned duct and/or that the inert gas inlet may be in fluid communication with an inert gas source (e.g. the higher pressure gas outlet of the gas pump), wherein a throttle valve may be located upstream of the inert gas inlet. The optional pressure controller may be configured to increase and/or decrease the power provided to the gas pump. It may further be configured to open and/or close the throttle valve, e.g. by powering an actuator. The optional pressure controller may hence as well control the flow speed of the inert gas flow. The optional pressure controller may be connected to at least one pressure sensor and/or flow speed sensor and may control the pressure and/or the flow speed in the process chamber in response to signals being provided by at least one of the pressure sensor and/or the flow speed sensor.

Changing the inert gas may have an impact of the signals being provided by flow speed and/or pressure sensors. This impact may require a recalibration of the sensors when changing the inert gas during manufacturing of a workpiece or between manufacturing of two workpieces. For example, when using an inert gas with an increased heat capacity and/or an increased thermal conductivity an anemometer configured for measuring the flow speed may require recalibration. For example, a hot wire anemometer experiences better cooling when increasing the thermal conductivity of the inert gas. Accordingly, the resistivity of the hot wire drops, which directly translates in presumably wrong flow speed readings, if the increased thermal conductivity is not considered. Similarly, a change of the (mean) molar mass and/or density of the inert gas may require a recalibration of the flow speed sensor, e.g., when using a vane anemometer or a cup anemometer.

In a preferred example, the process chamber further includes at least one second gas outlet in at least one of the bottom, the support, the opening walls and the opening bottom. The second gas outlet may be used when replacing a gas(mixture) such as air by the inert gas, e.g. by at least one of He and/or Ne and/or Ar and/or N₂, which may then preferably be provided to the volume via at least one second inert gas inlet in the ceiling. The use of expensive He and/or Ne or another inert gas can be reduced by each of these measures.

The optional second gas outlet may be connected to a second gas outlet control valve, preferably to a check valve configured to disable gas flow into the process chamber via the second gas outlet. Further, the second gas outlet may be connected by a tube or any other kind of conduit to a gas inlet of a second outlet vacuum pump.

As already apparent, the process chamber preferably includes at least one (laser) beam entry window, which may be located above the support. In a particularly preferred example, the process chamber further includes at least one inert gas jet stream inlet nozzle. As will be explained blow in more detail the term “Jetstream” used only to indicate that it is a second as well linguistically distinguishable gas stream flowing above the inert gas stream. The inert gas jet stream inlet nozzle may preferably be positioned in the upper portion of the process chamber and may preferably be oriented to provide an inert gas jet stream between the window and the support. Particularly preferred, the inert gas jet stream may attach to window surface and/or may be directed downwards. This can be obtained by orienting the inert gas jet stream inlet nozzle accordingly, e.g. by orienting inert gas jet stream inlet nozzle towards the window surface and/or by use of the Coanda effect.

Preferably opposite to the inert gas jet stream inlet nozzle may be at least one inert gas jet stream outlet nozzle, hence as well being positioned to provide an inert gas jet stream between the window and the support.

The inert gas jet stream may compensate for the effect that the smoke in a reduced density atmosphere tends to rise higher. The inert gas jet stream protects the window from being polluted by condensed or sublimated smoke, which as well would deteriorate beam quality and hence workpiece quality. The suggested measure thus enables to keep the vertical dimension of the volume reasonable, which reduces operating costs as well as installation costs and last but not least workpiece quality, as an increase in the distance between laser source and the powder decreases workpiece quality, as imperfections in beam focusing become more apparent.

For example, the at least one inert gas jet stream inlet nozzle may have a nozzle outlet opening being oriented parallel within an angle αⱼₛ to the (first) inert gas inlet, wherein αⱼₛ ∈A, and A={30°, 20°, 10°, 5°, 2.5°, 1°, 0.5°, 0° }. This measure reduces turbulences in the volume and hence increases efficient smoke removal from the volume.

Preferably, the flow speed of the inert gas jet stream relative to the window may be at least 1.1, 1.25, 1.5, 2, 2.5, 3, 3.5, 4, 4.5, 5, 7.5 and/or 10 times the flow speed of the inert gas flow 0.5 cm over the opening. This increased flow speed thus provides for a flow speed gradient from the bottom to the ceiling. This gradient enables to safely remove the smoke without blowing powder from the powder bed towards inert gas outlet.

In preferred example, the temperature of one the at least one optional inert gas jet streams may be below the temperature of the main inert gas stream, at least measured at the corresponding nozzle openings. Residues in the smoke can thus condense prior to reaching the window and no or at least less residues in the smoke condense on the window.

In another example, the temperature of one the at least one optional inert gas jet streams may be above the temperature of the main inert gas stream, at least measured at the corresponding nozzle openings. This allows to efficiently cool the powder bed by the main inert gas flow flowing preferably at least almost directly over the powder bed. This can be obtained by positioning the lower edged of the (first) inert gas inlet and/or the lower edge of the (first) inert gas outlet at the height of the edge of the support opening and/or at the height of the bottom or slightly above these heights. Slightly above means within at least one of 0.5 cm, 1 cm, 1.5 cm, 2 cm and/or 2.5 cm above the corresponding reference height. Further, the temperature of the main (first) inert gas flow from the (first) inert gas inlet to the (first) inert gas outlet may preferably be below ambient temperature, e.g. at or below at least one of 23° C., 20° C., 18° C., 10° C., 0°, −5° C., −10° C., −20° C. The lower the temperature, the better is the cooling, i.e. the heat transfer from the powder bed and/or the workpiece to the main inert gas stream. The temperature of the inert gas jet stream may be preferably at or above ambient temperature, e.g. at or above at least one of 25° C., 40° C., 60° C., 80° C., 100° C., 150° C., 250° C., 300° C., 350° C., 400° C., 450° C. This particularly preferred combination of having reduced temperature in the vicinity of the powder bed and an increased temperature above provides for both, a good cooling and low beam distortions.

Further, it may be preferred, if the vertical thickness of the main inert gas stream or flow is significantly smaller than the vertical thickness of the inert gas jet stream above the main inert gas stream. The vertical thickness of the respective streams can be controlled, e.g. by the vertical dimension of the respective inlet opening. Thus, the vertical dimension d₂ of the inert gas jet stream inlet may preferably be greater or equal to x-times the vertical dimension d₁ of the (first) inert gas inlet, wherein x∈{1.5, 2, 2.5, 5, 10, 15}, i.e. x·d₁≤d₂.

As apparent, both the main inert gas flow from the inert gas inlet nozzle to the inert gas outlet nozzle and the inert gas jet stream are “inert gas streams” the terms main inert gas stream and inert gas jet stream are used only to enable to linguistically distinguish these. Alternatively, one could have used first gas stream and second gas stream, but we consider the initially suggested wording to be more vivid. As apparent, in a preferred example the second inert gas stream (i.e. the inert gas jet stream) has a higher flow speed across the volume than the first (main) inert gas stream. The flow rate of the second inert gas stream may be higher than the first (=main) inert gas stream. Hence “main” does not have any implications regarding the amount of gas flowing per unit of time compared to other inert gas streams.

An additive manufacturing apparatus according to an embodiment may of course include the process chamber with at least one of the above explained features. In particular, the additive manufacturing apparatus may have one laser beam entry window and outside the process chamber, in front of the at least one window at least two (laser) beam sources each configured to emit at least one (laser) beam to a powder bed on top of the support. It is implicit that the window may be at least essentially transparent for the beams being emitted by the (laser) beam sources through the at least one window towards the support. In a preferred example, the additive manufacturing apparatus may be configured to scan a surface of a powder bed being below a smoke plume being produced by operation of a first (laser) beam source. This measure even allows to increase workpiece quality, e.g. by optimizing the thermal stress to the workpiece during manufacturing.

### BRIEF DESCRIPTION OF THE DRAWINGS

In the following, the invention will be described by way of example, without limitation of the general inventive concept, on examples of embodiment and with reference to the drawings.

FIG. 1 presents an example process chamber of an additive manufacturing apparatus.

FIG. 2 presents another example process chamber of an additive manufacturing apparatus.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

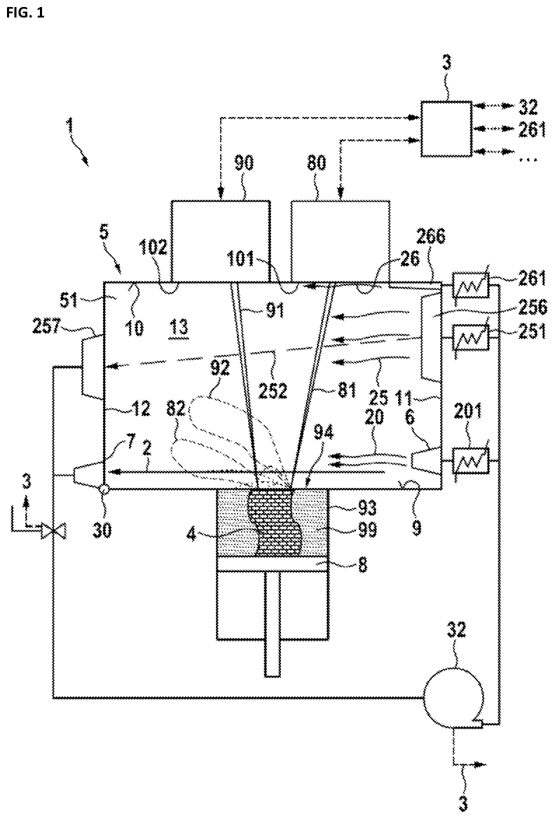

FIG. 1 is a simplified sectional view of an example additive manufacturing apparatus 1 with a process chamber 5. The process chamber 5 may have a volume 51 that may be enclosed by side walls 11, 12, 13 (a fourth side wall is not visible), a ceiling 10 and a bottom 9. The bottom 9 may have an opening 94 with opening walls 93. The opening walls 93 may provide a linear bearing for a movably supported support 8, which can be lowered and raised. On top of the support 8 may be an optional powder bed 99 in which a partially manufactured workpiece 4 may be embedded. The powder bed 99 and the workpiece 4 are depicted only as an example, but the additive manufacturing apparatus 1 and/or the process chamber 5 are/is typically delivered without any powder bed or workpiece.

The ceiling 10 may have windows 101, 102, being transparent for beams 81, 91, being emitted by beam sources 80, 90. Depicted are a first beam source 80 and a second beam source 90 emitting the first and the second beam 81, 91, respectively. Preferably, the process chamber 5 has more than two beam sources 80, 90. The window 101, 102 can as well be unitary and hence there may be at least one window above the opening 94 in the bottom.

An (first) inert gas inlet 6 in a front side wall 11 and an (first) inert gas outlet 7 in a rear side wall 12 enable to provide a main inert gas flow 20 across the opening 94 in the bottom 9, i.e. in a main inert gas flow direction 2. As can be seen, the main inert gas flow 20 may flow at least essentially parallel (i.e. ±αₘₛ (αₘₛ ∈{30°, 20°, 10°, 5°, 2.5°, 1°, 0.5°, 0° }) to the bottom 9 and hence at least essentially parallel to the powder bed surface and the powder bed supporting surface of the support 8. In the depicted example, the main inert gas flow direction 2 has a small downward component. Preferably, the inert gas comprises at least 20% Helium (He), and/or has a density below 1.4 kg/cm and/or a temperature above the dew point of the gas. In an example the pressure may be at or above ambient pressure. In another example the pressure may be at or below ambient pressure.

Above the main inert gas inlet 6 may be at least one optional second inert gas inlet 256 and at least one optional third inert gas outlets 266. Above the main inert gas outlet 7 may be at least one optional second inert gas outlet 257. These could as well be referred to an inert gas jet stream inlets or inert gas jet stream outlets, respectively.

In operation, a second inert gas stream may flow above the main (first) inert gas stream from the at least one optional second inert gas inlet 256 to the at least one optional second inert gas outlet 257. As indicated by the arrows 25, the volume per amount of time, i.e. the flow rate and/or the flow speed of the optional second inert gas flow 25 are/is preferably higher than the flow rate, and/or the flow speed, respectively of the main inert gas flow 20. Further, the downward component of the flow direction of the second inert gas flow direction 252 may preferably be greater than the downward component of main inert gas flow direction 2. The temperature of the second inert gas flow 25 may preferably be below the temperature of the main inert gas flow 20.

The optional third inert gas inlet 266 may preferably be located in the vicinity (within 10 cm, 5 cm, 2.5 cm and/or 1 cm) of the at least one window 101, 102 in the ceiling 10 and located to attach a third inert gas stream to the surface of the at least one window 101, 102, to thereby contribute to keep the at least one window 101, 102 clear of condensate. Preferably, the temperature of the inert gas exiting the third inert gas inlet may be above the temperature of the second inert gas entering the volume 51 via the at least one second inert gas inlet 256.

As indicated, each of the beams 81, 91 may be directed on a different location of the powder bed 99 and the fusing process produces first and a second smoke plumes 82, 92. As shown, the second beam 91 passes through the first smoke plume 82 originating from the interaction of the first beam 81 with the powder bed 99.

The inert gas may be removed by at least one pump 32, i.e. the first and second inert gas outlets 7, 257 are in fluid communication with the lower pressure inlet of the gas pump 32 which then feeds the inert gas to at least one of the inert gas inlets 6, 256, 266 via a duct 33. The temperature of the different inert gas streams can be controlled preferably by optional indirect heat exchangers 201, 251, 261.

A controller 3 may be connected by data and/or power lines to the beam sources 80, 90, sensors 30, the pump 32, valves 38, etc. Example connections are indicated by dashed or dotted arrows.

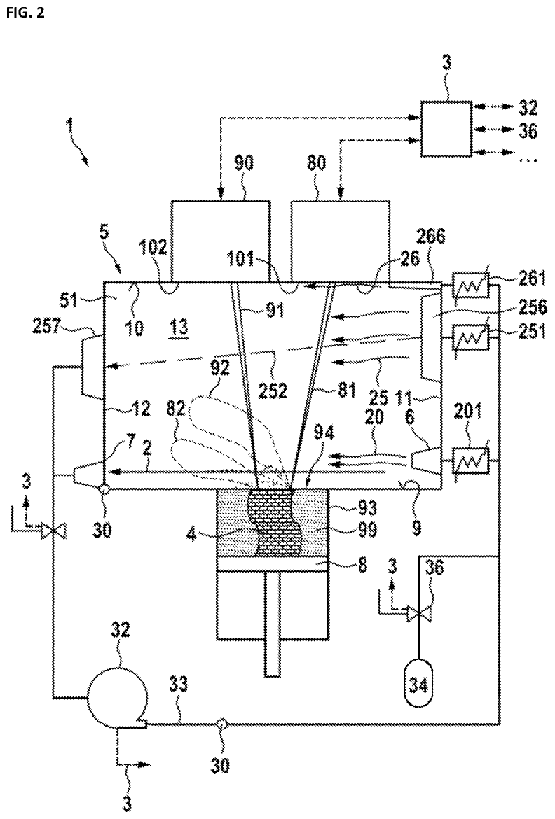

FIG. 2 presents another simplified sectional view of an example additive manufacturing apparatus 1 with a process chamber 5. The description of FIG. 1 can as well be read on FIG. 2. Only differences will be explained herein. Similar to FIG. 1, at least one of the inert gas outlets 7 and 257 of the process chamber 5 may be connected via a duct 33 with at least one of the inert gas inlets 6, 256, 266. A pump 32 may have a pump inlet being in fluid communication with at least one of the inert gas outlets 6, 25 and a pump outlet may be in fluid communication with at least one of the inert gas inlets 6, 256, 266 via the duct 33. The duct may include a gas component sensor 30. The values measured by the gas component sensors 30, regardless of its position, may be provided to the controller 3 by some data line or any other communication means. The controller may as well be referred to as process chamber controlling device 3.

The process chamber housing preferably has at least one of these gas component sensors 30. In FIG. 2, two gas component sensors 30 are depicted at preferred positions for illustrative purposes. Other numbers of gas composition sensors can be used as well.

The process chamber housing may further include at least one inert gas component source 34. In an example, the inert gas component source 34 may include a tank being filled or configured to be filled with, e.g., He and/or Ne or another inert gas or inert gas mixture.

The inert gas component source 34 may be fluidly connected via an inert gas component valve 26 with at least one of the inert gas inlets 6, 256, 266.

The controller 3 may preferably be configured to monitor based on at least one measured value the concentration and/or or partial pressure of at least one of He and Ne in the inert gas in the process chamber 5 and/or the duct 33. Such measurement values can be retrieved from at least one of the at least one inert gas component sensors 30. If the concentration of He and Ne in the inert gas in the process chamber 5 depletes below a predefined lower limit, the controller may be configured to open the inert gas component valve 36, e.g. for a given duration. The duration may be calculated, e.g. based on the difference between the lower limit and the measured value. By opening the inert gas component valve 36, the depleted inert gas component may be provided to the inert gas being provided to the process chamber. Thereby, the concentration of the depleted component, in this example He and/or Ne can be corrected. Similarly, if a measured concentration of another component of the inert gas in the process chamber 5 and/or the duct is above an upper limit, the controller may open the inert gas component valve 36 to thereby reduce the concentration of the component having a concentration above its upper limit. The process chamber may have a number of inert gas component sources 34 being filled with different inert gases and corresponding inert gas component valves 36 to selectively replenish a depleted inert gas component.

It will be appreciated to those skilled in the art having the benefit of this disclosure that this invention is believed to provide a process chamber housing for an additive manufacturing apparatus, an additive manufacturing apparatus and a method for fusing at least a portion of a layer of a powder bed. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 additive manufacturing apparatus
2 main inert gas flow direction
3 controller/process chamber controlling device
4 workpiece/adhered moieties of raw material
5 process chamber
6 gas inlet
7 gas outlet
8 support
9 bottom
10 ceiling
101 window
102 window
11 first sidewall
12 second sidewall
13 third sidewall
20 main inert gas flow
201 heat exchanger
25 second inert gas flow (inert gas jet stream flow)
251 heat exchanger
252 direction of second inert gas flow
256 second inert gas inlet
257 second inert gas outlet
26 third inert gas flow
261 heat exchanger
266 third inert gas inlet
30 gas component sensor, e.g. oxygen sensor and/or a gas density sensor and/or gas component concentration sensor,
32 pump
33 duct
34 inert gas component source
35 heater
36 inert gas component valve
50 recoater
80 first beam source
81 first beam/first laser beam
82 first smoke plume
90 second beam source
91 first beam/first laser beam
92 second smoke plume
93 opening walls
94 support opening in bottom 9, configured to receive support 8
99 powder bed

1. A process chamber housing for an additive manufacturing apparatus, the process chamber housing comprising:
a process chamber having a volume;
a bottom, a ceiling, and side walls jointly enclosing said volume of the process chamber,
an inert gas inlet configured to provide an inert gas into the process chamber,
an inert gas outlet configured to release the inert gas out of the process chamber, wherein
the bottom has an opening that is delimited by opening walls (93); and a vertically movable support configured to support a three dimensional object is located in between the opening walls, and/or
the inert gas inlet is configured to provide a light inert gas, having a density of less than 1.4 kg/m³, into the process chamber.

2. The process chamber housing of claim 1, wherein the inert gas inlet and the inert gas outlet are positioned at opposite sides of the process chamber and/or the opening, thereby being configured to establish an inert gas flow in a main flow direction from the inert gas inlet over the opening to the inert gas outlet.

3. (canceled)

4. The process chamber housing of claim 1, wherein the inert gas inlet is connected to a gas source providing a gas or gas mixture with a thermal conductivity of at least
$$0.1 \frac{W}{m \cdot K} .$$

5. The process chamber housing of claim 1, further comprising a gas source configured to provide a gas in which an amount mol % of He and/or Ne to a total amount of gas is at least one of 20%, 30%, 40%, 50%, 60%, 70%, 80%, 90%, 95%, 98%, and 99%.

6. The process chamber housing of claim 1, configured to provide the inert gas flow in the main flow direction with a flow speed, the flow speed having a mean value flow speed of higher than 0.75 m/s and/or lower than 4 m/s as measured at a location 0.5 cm over the opening.

7. The process chamber housing of claim 1, wherein
the process chamber comprises at least one gas component concentration sensor located on the bottom, and/or
in a recess of the bottom, and/or
at a distance of less than 5 cm above the bottom, and/or
on the support and/or below the support, and/or
at or within at least one of 10 cm, 5 cm, 2.5 cm, 1 cm, and 0.5 cm from an edge in the bottom, said edge encircling the opening, and/or
in a duct connecting the inert gas outlet with the inert gas inlet.

8. The process chamber housing of claim 7, wherein the process chamber housing further comprises at least one inert gas component source that is fluidly connected via an inert gas component valve with the inert gas inlet of the process chamber.

9. The process chamber housing of claim 1, wherein
the process chamber comprises a heater configured to increase a temperature of at least a portion of the inert gas flow through the process chamber to or above at least one of 25° C., 40° C., 60° C., 80° C., 100° C., 150° C., 250° C., 300° C., 350° C., 400° C., and 450° C.

10. The process chamber housing of claim 1, wherein the process chamber comprises a pressure controller configured to maintain a pressure inside the process chamber below an ambient pressure outside the process chamber and/or at or below at least one of 1000 hPa, 900 hPa, 800 hPa, 700 hPa, 600 hPa, 500 ha, 400 hPa, 300 hPa, 200 hPa, and 100 hPa.

11. The process chamber of claim 1, wherein
the inert gas outlet is in fluid communication with a vacuum pump and/or wherein the inert gas inlet is in fluid communication with an inert gas source, wherein a throttle valve is located upstream of the inert gas inlet.

12. The process chamber housing of claim 1, wherein the process chamber further comprises:
at least one auxiliary inert gas outlet in at least one of the bottom, the support, the opening walls, and the opening bottom and/or
at least one auxiliary inert gas inlet in the ceiling.

13. The process chamber housing of claim 12, wherein
the at least one auxiliary inert gas outlet is connected to an auxiliary gas outlet control valve configured to disable gas flow into the process chamber via the at least one auxiliary inert gas outlet and/or
the at least one auxiliary inert gas outlet is connected to a gas inlet of an auxiliary inert gas outlet vacuum pump.

14. The process chamber housing of claim 1, further comprising at least one laser beam entry window located above the opening.

15. The process chamber housing of claim 14, further comprising:
at least one inert gas jet stream inlet nozzle, positioned to provide an inert gas jet stream between the at least one laser beam entry window and the support, and/or
at least one inert gas jet stream outlet nozzle, positioned to provide an inert gas jet stream between the at least one laser beam entry window and the support.

16. The process chamber housing of claim 15, wherein the at least one inert gas jet stream inlet nozzle has a nozzle outlet opening oriented either parallel to or within
an angle αⱼₛ with respect to the inert gas inlet, wherein αⱼₛ∈A, and
A={30°,20°,10°,5°,2.5°,1°,0.5°,0°}

17. (canceled)

18. (canceled)

19. A method for fusing at least a portion of a layer of a powder bed, the method comprising at least:
emitting at least a first beam from a first beam source onto first locations of the powder bed and at least a second beam from a second beam source onto second locations of the powder bed to produce a first smoke plume and a second smoke plume, respectively, wherein the first and second locations are different;
inclining the first and the second smoke plumes towards the horizontal by establishing an established inert gas flow that has a direction with a component that is parallel to the powder bed, wherein
at least some of the second locations are selected to be positioned below the first smoke plume, wherein below indicates that the first smoke plume is in between the second beam source and said some of the second locations and/or
wherein a density of the inert gas flow is at or below 1.4 kg/m³ at normal conditions and/or at conditions at a distance of 20 mm above the layer.

20. The method of claim 19, wherein
a distance between locations of the first locations and/or of the second locations is shorter than at least one of 100 mm, 70 mm, 40 mm, 30 mm, 20 mm and 10 mm; and/or wherein
a distance between a first location of the first locations and a second location of the second locations is shorter than at least one of 100 mm, 70 mm, 40 mm, 30 mm, 20 mm, and 10 mm, wherein a duration of time between moments when the first and second beams are emitted towards said first location and said second location is shorter than at least one of 10%, 20%, 30%, 40%, 50%, 60%, 70% and 80% of a maximum time span during which the first beam or the second beam is emitted towards the layer.

21. The method of claim 19, wherein
the established inert gas flow comprises He and/or Ne, in an amount of mol % relative to a total amount of gas, of at least one of 20%, 30%, 40%, 50%, 60%, 70%, 80%, 90%, 95%, 98%, 99%.

22. The method of claim 19, wherein the established inert gas flow has a temperature at or above at least one of 25° C., 40° C., 60° C., 80° C., 100° C., 150° C., 250° C., 300° C., 350° C., 400° C., and 450° C.

23. A method for fusing at least a portion of a layer of a powder bed, the method comprising at least:
emitting at least a first beam from a first beam source onto first locations of a powder bed to produce a first smoke plume;
inclining the first smoke plume towards the horizontal by establishing an inert gas flow having a direction with a component that is parallel to the powder bed,
feeding at least a portion of an inert gas mixture removed through an inert gas outlet to an inert gas inlet of a process chamber,
measuring a measurement value representing a concentration and/or a partial pressure of at least one of N₂, He, Ne, Ar, Kr and Xe in the inert gas mixture that is removed from the process chamber or that is inside the process chamber,
comparing this measurement value with a lower limit and/or with an upper limit of the concentration and/or the partial pressure of the at least one of N₂, He, Ne, Ar, Kr and Xe in the inert gas mixture, and
in case when said comparing provides that measurement value is below the lower limit, adding a corresponding first component to the inert gas mixture, while adding no or less of at least one other component of the inert gas mixture to the inert gas mixture, and/or
in case said comparing provides that this measurement value is above the upper limit, adding at least one other component than said component having a measurement value above the upper limit to the inert gas mixture, while adding no or less of said component having a measurement value above the upper limit to the inert gas mixture.

24. (canceled)
